(19) United States
(12) Patent Application Publication
(10) Pub. No.: US 2005/0047455 A1
(43) Pub. Date: Mar. 3, 2005

(54) Laser diode module

(75) Inventor: Hiroshi Tanaka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/891,193

(22) Filed: Jul. 15, 2004

(30) Foreign Application Priority Data
Jul. 28, 2003 (JP) 2003-202413

(51) Int. Cl. H01S 3/10

(52) U.S. Cl. 372/28; 372/26; 372/38.08

(57) ABSTRACT

An LD 12, a high-frequency superposing circuit for superposing a high-frequency current on the LD and an EMC management component for reducing electromagnetic noise generated from the high-frequency superposing circuit are integrated into a module. The LD is mounted on a surface of a multi layer board 21 while at least one part of the high-frequency superposing circuit and the EMC management component is included in the inside of the multilayer board. Components 18 mounted on the surface of the board, except the LD, are molded with a resin to form a resin molding portion 31. The resin molding portion 31 serves as a positioning guide when the module is mounted. Heat-radiating through-holes 20 are provided in the mount portion of the LD.

### BACKGROUND OF THE INVENTION

The present invention relates to a laser diode module and particularly to a semiconductor laser module used in an optical disk device such as a DVD drive, a CD drive or an MO drive.

An optical disk device using an optical disk such as a DVD or an MO disk as a recording medium is provided with an optical pickup having a built-in semiconductor laser diode (hereinafter referred to as LD) for performing recording and reproduction of information by means of irradiating the disk with a light beam generated from the LD.

The light beam, inclusive of playback information, reflected from the disk is led to a photo detector (hereinafter referred to as PD) by a beam splitter. It is however difficult to lead all the reflected light beam to the PD. Part of the reflected light beam is incident onto the LD and causes return beam noise which deteriorates a playback signal.

Therefore, in a background-art optical pickup, a high-frequency superposing circuit is generally used for superposing a high-frequency current of the order of hundreds of MHz on a drive current of the LD to widen the spectral line width of the LD (into a multi-mode) to thereby eliminate the influence of the return beam noise. Electromagnetic noise is however generated with the superposition of the high-frequency current. To reduce the electromagnetic noise, an EMC (electromagnetic compatibility) management circuit is provided.

This type optical pickup devices have been disclosed in the following Patent Documents.

Japanese Patent Laid-Open No. 2002-230812

Japanese Patent Laid-Open No. H6-259798/(1994)

Japanese Patent Laid-Open No. 2001-307372

Incidentally, when an optical disk device or an optical pickup is designed and produced, an LD chip, a high-frequency superposing circuit and an EMC management component (circuit) are generally prepared so that these are combined to form an optical disk device.

The work for adding the high-frequency superposing circuit or the EMC management component to the LD is however burdensome to the designer of the device maker. This work causes a delay of design and production of the optical disk device. This is because the configuration of each of the high-frequency superposing circuit and the EMC management component cannot be decided independently, that is, the optimum circuit configuration thereof varies widely in accordance with the kind and characteristic (wavelength, input impedance, etc.) of the used LD or the circuit pattern of the board on which the LD is mounted. Accordingly, design of the superposing circuit and the EMC management component, adjustment of the quantity of superposition, confirmation of the operation of the LD, inspection of radiant noise, etc. have to be executed whenever an optical pickup is designed. Much time and labor is required for these.

The aforementioned Patent Documents have not disclosed any technique for solving the problem accompanying the high-frequency superposition and EMC management.

On the other hand, use of a laser diode (LD) capable of performing self-oscillation, that is, use of a multi-mode (self-excited) laser diode requiring no high-frequency superposing circuit may be conceived.

In the present circumstances, it is however difficult to mass-produce the multi-mode LD with good yield. Moreover, the temperature range for stable oscillation in the multi-mode LD is narrower than that in the single-mode LD. Accordingly, there is a disadvantage in that the multi-mode LD lacks reliability because of a large amount of spent electric power and a large amount of generated heat. Particularly, as the wavelength becomes shorter, the energy density (e.g. in the DVD purpose requiring a shorter wavelength) becomes higher and the amount of generated heat becomes higher. For this reason, it is difficult to control the amount of generated heat stably. In addition, a large-scale heat-radiating structure is required to make it difficult to reduce the size of the optical disk device.

Although the EMC (electromagnetic compatibility) Standard provided for reducing electromagnetic noise generated from or received in electronic appliances to a level not higher than a predetermined level has been strengthened internationally in recent years, the life cycle of the electronic appliances has shown a downward trend. For this reason, there is a demand for shortening the period required for developing and designing products as well as reduction in size and increase in grade and number of functions. Accordingly, the situation that valuable technical, capital or human resources are spared for designing the superposing circuit and managing the EMC cannot be said to be favorable to the maker of the optical disk device.

### SUMMARY OF THE INVENTION

Therefore, an object of the invention is to provide an LD module in which handling property equivalent to that of a multi-mode LD can be provided to the optical pickup designer while excellent characteristic of a single-mode LD can be sustained.

To achieve the foregoing object so as to solve the problem, the invention provides a first laser diode module having an LD (single-mode semiconductor laser diode), and a high-frequency superposing circuit for superposing a high-frequency current on a drive current of the LD, the high-frequency superposing circuit being integrated with the LD to provide a module.

In the first laser module according to the invention, the LD and the high-frequency superposing circuit are incorporated in a module in advance to provide the module as a part unit. The high-frequency superposing circuit incorporated in the module is formed in accordance with the LD (i.e. designed to be fit for the LD). Accordingly, an optical pickup designer can form an optical pickup by incorporating the module directly without burdensomeness of designing the high-frequency superposing circuit and adjusting the quantity of superposition.

According to a second laser diode module provided by the invention, the first module further has an EMC (electromagnetic compatibility) management component provided in the module for reducing electromagnetic noise generated from the high-frequency superposing circuit.

According to the structure of the second module, an optical pickup designer can design an optical pickup more easily because it is unnecessary to consider the EMC management. Hence, according to the invention, handling property equivalent to that of a multi-mode LD can be obtained at the time of development and designing of an optical pickup while excellent characteristic (e.g. low power consumption, wide operating temperature range for stable operation, good mass production, reduction in cost of the optical pickup, etc.) of the single-mode LD can be sustained.

The EMC management component used in the invention cannot be specified concretely to design an optimum component element or circuit configuration in accordance with the kind and characteristic (e.g. input impedance) of the used LD. For example, the EMC management component may be constituted by passive elements such as inductors (coils), capacitors (condensers) and resistors or by a circuit formed from a combination of these passive elements.

The module according to the invention can be used in any optical disk device using an optical disk such as a DVD, a CD, an MD (Mini Disk), an MO (Magneto-optical) disk, an optical video disk, an optical PCM audio disk, etc. as a recording medium.

Preferably, in each of the first and second modules, the single-mode LD is mounted on a surface of a multilayer board; and at least one part of circuit elements constituting the high-frequency superposing circuit is included in the inside of the multilayer board.

This is because reduction in size of the module can be attained when at least one part of circuit elements constituting the high-frequency superposing circuit are disposed in the inside of the multilayer board.

Preferably, for the same reason, the single-mode LD is mounted on a surface of a multilayer board; and at least one part of circuit elements constituting the EMC management component is included in the inside of the multilayer board.

The multilayer board may have a nearly square planar shape with a pair of upper and lower sides opposite to each other and a pair of left and right sides opposite to each other, so that the single-mode LD is mounted in a position which is substantially in the center between the pair of left and right sides and near one of the pair of upper and lower sides.

When the LD is disposed in the center between the pair of left and right sides of the multilayer board substantially shaped like a square in plan view as described above, the optical axis of the LD can be aligned by reference to the center (center line) of the module (board) at the time of incorporating the module in an optical pickup. Accordingly, the work of mechanically designing (arranging parts) an optical pickup including the module and attaching the module to the optical pickup can be performed easily. When the LD is disposed near the lower side of the board, the course (optical path) of a laser beam can be prevented from being disturbed or reflected/scattered by the end portion of the board when the LD is mounted on the board surface.

In the invention, the multilayer board may have a nearly square planar shape with a pair of upper and lower sides opposite to each other and a pair of left and right sides opposite to each other, so that external connection terminals are formed in any one of the pair of upper and lower sides.

This is because the LD module can be easily connected to various kinds of input/output lines (such as an input line for supplying a drive current to the LD, a ground line and an output line for PD controlling the LD) when the external connection terminals are collectively formed in any one of the pair of upper and lower sides of the board.

Surface-mounted components may be provided on the surface of the multilayer board so that at least one part of the surface-mounted components except the LD can be molded with a resin to form a resin portion.

According to this configuration, while the surface-mounted components can be kept electrically insulated, the surface-mounted components can be protected mechanically and physically so that, for example, the surface-mounted components can be prevented from being broken at the time of assembling.

At least one part of an outer surface of the resin portion formed by molding the surface-mounted components may abut on a wall surface of a mount portion for mounting the LD module (e.g. an inner wall surface of a housing frame of the optical pickup) to thereby make it possible to position the LD module.

According to the structure of the module, the LD module can be incorporated in the optical pickup more easily and more efficiently because the resin portion formed by molding serves also as a positioning guide.

Through-holes for radiating heat from the LD maybe formed in the multilayer board.

This is because the heat-radiating characteristic of the LD mounted on the board surface can be kept. Specifically, when, for example, heat-radiating via-holes for heat-conductively connecting the LD and the ground on the rear surface of the board is formed in the LD mount portion, heat generated from the LD can be radiated. For example, such heat-radiating through-holes can be provided as a structure in which the inside of each plated through-hole is filled with a heat-conductive material (such as electrically conductive resin paste). When higher heat-radiating characteristic needs to be kept, it is preferable from the point of view of heat-radiating efficiency that the through-holes are provided as a so-called “filled via” structure in which the inside of each through-hole is filled with a plating metal precipitated in the form of a column.

### BRIEF DESCRIPTION OF THE DRAWINGS

FIG. 1 is a block diagram showing an example of an LD module according to the invention.

FIG. 2 is a plan view typically showing an example of the LD module according to the invention.

FIG. 3 is a front view (of the LD-mounting side surface) typically showing an example of the LD module according to the invention.

FIG. 4 is a rear view (of the external connection terminal-forming side surface) typically showing an example of the LD module according to the invention.

FIG. 5 is a side view typically showing an example of the LD module according to the invention.

FIG. 6 is a sectional view (taken along the line A-A in FIG. 2) typically showing an example of the LD module according to the invention.

### DETAILED DESCRIPTION OF THE PREFERRED EMBODIMENTS

A mode for carrying out the invention (hereinafter referred to as embodiment) will be described below with reference to the accompanying drawings.

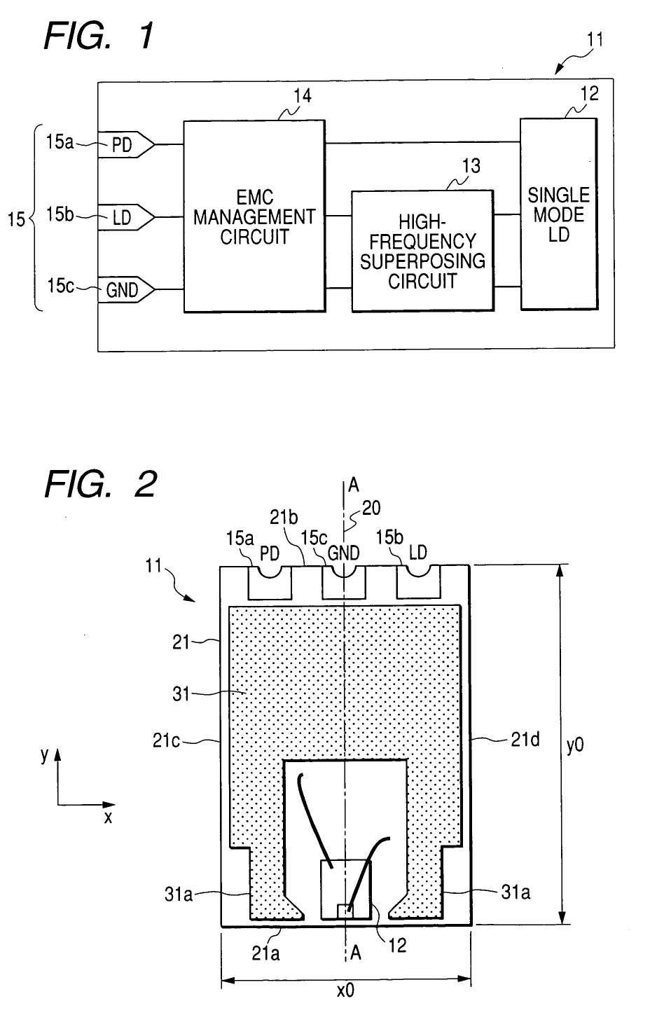

FIGS. 1 to 6 show an example of an LD module according to the invention. In FIGS. 1 to 6, identical or similar parts are denoted by the same reference numerals.

As shown in FIG. 1, the LD module 11 has a single-mode LD 12 for generating a laser beam for reading/writing information from/in an optical disk, a high-frequency superposing circuit 13 for superposing a high-frequency current on a drive current of the LD 12, and an EMC management circuit 14. A multilayer board 21 (see FIGS. 2 to 6) is used for integrating these constituent members 12 to 14 into a module.

The LD 12 is mounted on a surface of the multilayer board 21 in such a manner that electrode pads of the LD 12 are wire-bonded to conductor patterns of the multilayer board 21. The LD 12 is connected to the high-frequency superposing circuit 13 and the EMC management circuit 14 through conductor patterns (not shown) formed on and in the multilayer board 21. The LD 12 is connected to an external connection terminal set 15 through the high-frequency superposing circuit 13 and the EMC management circuit 14.

The external connection terminal set 15 includes an input terminal 15b for supplying a drive current to the LD 12, a ground terminal 15c, and an output terminal 15a for PD (photo detector) controlling the LD 12. These external connection terminals 15a to 15c are collectively disposed at an end of the board 21 to make it easy to connect input/output lines to the LD module 11. The EMC management circuit 14 is constituted by passive elements such as inductors, capacitors, etc. The EMC management circuit 14 is provided between the high-frequency superposing circuit 13 and the external connection terminal set 15 and between the LD 12 and the external connection terminal set 15.

The multilayer board 21 may be constituted by a ceramic multilayer board, for example, using an electrically insulating layer of ceramics. Or the multilayer board 21 maybe constituted by an organic resin board or a composite material board made of a composite material as an organic material-inorganic filler mixture. Or the multilayer board 21 may be constituted by a so-called aggregate board formed in such a manner that a large board material is cut and separated into individual boards. For example, the conductor patterns may be formed by a thick-film method of printing conductor paste on a ceramic plate or may be formed by a thick-film method such as sputtering.

The multilayer board 21 is substantially shaped like a rectangular parallelepiped (i.e. like a rectangle in plan view) In top view (see FIG. 2), the multilayer board 21 has a pair of lower and upper sides 21a and 21b opposite to each other, and a pair of left and right sides 21c and 21d opposite to each other. The LD 12 is disposed in a position which is substantially in the center (i.e. on a center line 20 along the lengthwise direction of the board 21) between the pair of left and right sides 21c and 21d and near one 21a (opposite to the external connection terminal set 15) of the pair of lower and upper sides 21a and 21b. This is because the optical axis of the LD 12 can be aligned easily when the LD module 11 is incorporated in an optical pickup and because the disposition of the LD near the lower side of the board 21 can prevent the optical path of the laser beam from being disturbed by the end portion of the board.

The laser beam emitted from the LD 12 is not perfectly parallel rays but has a predetermined spread. The spread is formed so that a horizontal spread is not equal to a vertical spread. For this reason, the necessity of mounting the LD 12 while rotating the LD 12 at a slight angle (of several degrees) around the optical axis may occur in accordance with the configuration of an optical system provided in the rear stage or the relation in arrangement between the LD 12 and the disk. In such a case, the module 11 can be rotated around the center line 20 of the module 11 without causing positional displacement of the optical axis of the LD 12 if the LD 12 is mounted in the center (i.e. on the center line 20 along the length wise direction) of the module 11 while the optical axis of the LD 12 is made coincident with the center line of the module 11 (of the board 21) as described in this embodiment. As a result, it is possible to provide an LD module which can be designed easily by the user (the maker of the optical disk device) and which can be handled easily by the user.

Incidentally, it is preferable that the LD 12 is located not in a position tangent to the lower side 21a of the board 21 (i.e. a position just along the lower side 21a) but in a position retreating inward from the lower side 21a. This is because the accident of a collision of the LD 12 to break the LD 12 can be prevented when the LD module 11 is mounted or handled and because the LD 12 can be surely placed (mounted) on the board even in the case where positional displacement error occurs in the lengthwise direction of the board.

Besides the LD 12, surface-mounted components 18, that is, passive elements such as transistors, etc., chip capacitors and chip resistors for constituting the high-frequency superposing circuit 13 and the EMC management circuit 14 are mounted on the surface of the multilayer board 21. These surface-mounted components 18 are sealed by resin-molding to form a molding portion (resin portion) 31. The molding portion (resin portion) 31 is provided for electrically insulating the surface-mounted components 18 on the board surface while protecting the surface-mounted components 18 from breaking physically and mechanically. The molding portion (resin portion) 31 serves also as a positioning guide when the LD module 11 is attached to an optical pickup (optical disk device).

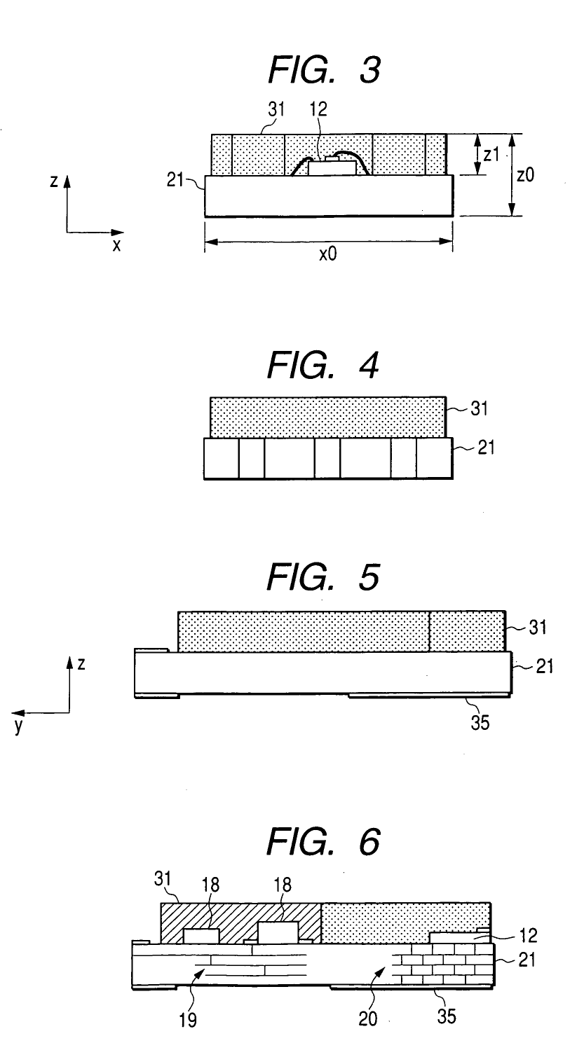

That is, as is obvious from FIGS. 3 to 6, the resin portion 31 has an upper surface which is nearly flat, and a predetermined thickness z1. Accordingly, the LD module 11 has a predetermined thickness z0. Accordingly, when a three-dimensional orthogonal coordinate system with the direction of the width of the module 11 as an x axis, the direction of the length of the module 11 as a y axis and the direction of the thickness of the module 11 as a z axis is assumed as shown in FIGS. 2, 3 and 5, the LD module 11 can be positioned, for example, in such a manner that alignment in the x direction is limited by the width x0 of the board 21, alignment in the y direction is limited by the lower side 21a of the board 21 and alignment in the z direction is limited by the thickness z0 of the module 11.

The structure of an optical pickup (optical disk device) side fixing portion for accepting and fixing the LD module 11 is not particularly limited. For example, a hole or cavity just fit for the LD module 11 may be formed in a housing frame of the optical pickup (optical disk device) so that the LD module 11 can be inserted and fitted into the fixing portion. In this case, the dimensions of an inner surface of the fixing portion may be preferably set so that the inner surface of the fixing portion has a width equal to the width x0 of the LD module 11 and a height equal to the thickness z0 of the LD module 11.

The resin portion 31 has a height z1 (thickness) larger than the height of the LD 12 (see FIG. 3). The resin portion 31 includes two arm portions 31a (see FIG. 2) so that the left and right of the LD 12 are surrounded by the arm portions 31a. The arm portions 31a can prevent the LD 12 from being damaged when the LD module 11 is handled.

Passive elements (such as inductors and capacitors) and conductor patterns (designated by the reference numeral 19 in FIG. 6) for forming the high-frequency superposing circuit 13 and the EMC management circuit 14 are formed in the inside of the board 21. When passive elements for forming the high-frequency superposing circuit 13 and the EMC management circuit 14 are partially formed in the inside of the multilayer board 21 in this manner, the size of the LD module 11 can be reduced.

Heat-radiating conductor patterns and through-holes 20 are provided in a portion of the multilayer board 21 on which the LD 12 is mounted. Heat radiation is performed in such a manner that heat generated from the LD 12 is led to a ground pattern 35 on the rear surface of the board through the conductor patterns and through-holes 20. For example, the heat-radiating through-holes 20 maybe formed as a structure in which the inside of each plated through-hole is filled with a heat-conductive material as described above. Or the heat-radiating through-holes 20 may be formed as a so-called “filled via” structure in which the inside of each through-hole is filled with a plating metal precipitated in the form of a column in order to keep heat-radiating characteristic higher.

Table 1 shows the advantage of the LD module according to this embodiment in comparison with the background-art single-mode LD and the background-art multi-mode LD.

TABLE 1

| | LD | Single- | Multi- | |
|---|---|---|---|---|
| Evaluation Item | Module | Mode LD | Mode LD | Remarks |
| Radiant Noise | ◯ | X (See | ◯ | Single-mode LD needs |
| Measures | | remarks) | | EMC measures. |
| Available | ◯ | ◯ | X (See | The temperature range for |
| Temperature Range | | | remarks) | stable oscillation is narrow. |
| Amount of Heat | ◯ | ◯ | X (See | The amount of generated |
| generated in Laser | | | remarks) | heat is large compared with |
| | | | | single-mode LD. |
| Spent Current | ◯ | ◯ | X (See | The operating (spent) current |
| | | | remarks) | of the laser is high compared |
| | | | | with single-mode LD. |
| Reliability | ◯ | ◯ | X (See | Reliability is low because of |
| | | | remarks) | heat generation and |
| | | | | temperature characteristic |
| | | | | compared with single-mode |
| | | | | LD. |
| Availability | ◯ | ◯ | X (See | Quantity of supply is |
| | | | remarks) | insufficient because of |
| | | | | difficulty in mass |
| | | | | production. |
| Price | — | — | — | Substantially equal |

As shown in Table 1,the single-mode LD is excellent in respective aspects of the available temperature range, the amount of heat generated in the laser, the spent current, the reliability and the availability but has a disadvantage in that the EMC management circuit must be disposed for taking measures against radiant noise because the high-frequency superposing circuit is provided. The multi-mode LD has an advantage in that it is unnecessary to consider EMC management because it is unnecessary to provide any high-frequency superposing circuit. The multi-mode LD however has a disadvantage in that the temperature range for stable oscillation is narrow, the amount of generated heat and the operating (spent) current of the laser are large compared with the single-mode LD and the reliability is low because of the heat generation and the temperature characteristic. Moreover, it is difficult to mass-produce the multi-mode LD with good yield. Accordingly, the multi-mode LD has a disadvantage in that the multi-mode LD is not available because the multi-mode LD cannot be supplied sufficiently on the market.

On the contrary, the LD module according to this invention (this embodiment) is formed so that the high-frequency superposing circuit is included in the inside of the module, and that EMC management is performed in the module in advance. Accordingly, the designer of the optical pickup is freed from the burdensomeness of designing and adjusting the EMC management because the EMC management need not be considered. In addition, all advantages in excellent characteristic of the single-mode LD, that is, in the radiant noise measures, the available temperature range, the amount of heat generated in the laser, the spent current, the reliability and the availability can be enjoyed. With respect to the cost aspect, the cost can be kept substantially equal to that of the single-mode LD. As described above, in accordance with this embodiment, the optical pickup can be designed easily, and handling property equivalent to that of the multi-mode LD and excellent characteristic of the single-mode LD can be obtained simultaneously.

Although the embodiment of the invention has been described above, the invention is not limited thereto and it will be clear to those skilled in the art that various changes may be made without departing from the scope of claim. For example, the LD mounted in the LD module according to the invention may be used regardless of whether the wavelength of the LD is long or short if the LD is a single-mode LD requiring a high-frequency superposing circuit. For example, the LD may be a visible light LD or may be a blue-violet LD with a shorter wavelength. The number of LDs mounted in (integrated with) the module need not be limited to one. For example, a plurality of LDs (e.g. two LDs) different in wavelength may be incorporated in the module according to the invention so that the LD module used for recording and reproduction of both CD and DVD can be formed. The kind of the optical disk device used is not limited. For example, the LD module can be used in optical disk devices such as a DVD, a CD, an MD (Mini Disk), an MO disk (Magneto-Optical disk), an optical video disk, an optical PCM audio disk, etc.

### EFFECT OF THE INVENTION

As described above, in accordance with the LD module provided by the invention, handling property equivalent to that of a multi-mode LD can be provided to an optical pickup designer while excellent characteristic of a single-mode LD can be sustained.

1. A laser diode module comprising:
a single-mode semiconductor laser diode; and
a high-frequency superposing circuit for superposing a high-frequency current on a drive current of said laser diode,
wherein said high-frequency superposing circuit is integrated with said laser diode to provide a module.

2. A laser diode module according to claim 1, further comprising an EMC management component for reducing electromagnetic noise generated from said high-frequency superposing circuit, which is integrated as the module.

3. A laser diode module according to claim 1, wherein said single-mode semiconductor laser diode is mounted on a surface of a multilayer board; and
at least one part of circuit elements constituting said high-frequency superposing circuit is included in the inside of said multilayer board.

4. A laser diode module according to claim 2, wherein said single-mode semiconductor laser diode is mounted on a surface of a multilayer board; and
at least one part of circuit elements constituting said EMC management component is included in the inside of said multilayer board.

5. A laser diode module according to claim 3 or 4, wherein said multilayer board has a nearly square planar shape with a pair of upper and lower sides opposite to each other and a pair of left and right sides opposite to each other; and
said single-mode semiconductor laser diode is mounted in a position which is substantially in the center between said pair of left and right sides and near one of said pair of upper and lower sides.

6. A laser diode module according to claim 3 or 4, wherein said multilayer board has a nearly square planar shape with a pair of upper and lower sides opposite to each other and a pair of left and right sides opposite to each other; and
external connection terminals are formed in any one of said pair of upper and lower sides.

7. A laser diode module according to claim 3 or 4, wherein surface-mounted components are provided on said surface of said multilayer board; and
at least one part of said surface-mounted components except said single-mode semiconductor laser diode is molded with a resin to form a resin portion.

8. A laser diode module according to claim 7, wherein at least one part of an outer surface of said resin portion formed by molding said surface-mounted components abuts on a wall surface of a mount portion for mounting said laser diode module to thereby make it possible to position said laser diode module.

9. A laser diode module according to claim 3 or 4, wherein through-holes for radiating heat from said single-mode semiconductor laser diode are formed in said multilayer board.

10. A laser diode module according to claim 5 or 6, wherein surface-mounted components are provided on said surface of said multilayer board; and
at least one part of said surface-mounted components except said single-mode semiconductor laser diode is molded with a resin to form a resin portion.

11. A laser diode module according to claim 10, wherein at least one part of an outer surface of said resin portion formed by molding said surface-mounted components abuts on a wall surface of a mount portion for mounting said laser diode module to thereby make it possible to position said laser diode module.
